(19) United States
(12) Patent Application Publication
(10) Pub. No.: US 2016/0012810 A1
(43) Pub. Date: Jan. 14, 2016

(54) WHISTLE PLAY STOPPER

(71) Applicant: ProSports Technologies, LLC, Miami, FL (US)

(72) Inventors: John E. Cronin, Bonita Springs, FL (US); Nick Reasner, Chicago, IL (US)

(21) Appl. No.: 14/798,049

(22) Filed: Jul. 13, 2015

Related U.S. Application Data
(60) Provisional application No. 62/023,393, filed on Jul. 11, 2014.

(51) Int. Cl. G10K 5/00; G08B 7/00; A63B 71/06; G04G 21/00

(52) U.S. Cl. CPC G10K 5/00; G04G 21/00; G08B 7/00; A63B 71/06

(57) ABSTRACT

Systems and methods for notifying game-based clocks and players associated with a sporting event using one or more digital whistles are described. More specifically, the one or more digital whistles, for example used by referees, transmit one or more digital signals upon being used. The transmitted digital signals are received by a whistle processor that processes the transmitted digital signals and transmits instructions to the game-based clocks and players in the sporting event for controlling timekeeping and facilitating a flow of the sporting event.

### CROSS-REFERENCE TO RELATED APPLICATIONS

The present application claims the priority benefit of U.S. provisional application No. 62/023,393 filed Jul. 11, 2014 and entitled “Whistle Play Stopper,” the disclosure of which is incorporated herein by reference.

### BACKGROUND OF THE INVENTION

1. Field of Invention

The present invention generally relates to whistles utilized by referees in sporting events. More specifically, the present invention relates to wireless actuators associated with the whistles utilized by referees in sporting events.

2. Description of the Related Art

In many sporting events, various individuals (e.g., officials, referees, umpires) are responsible for presiding over the game from a neutral point of view. These individuals may make numerous quick decisions directed at enforcing the rules of the respective sport they are overseeing.

In some sports (e.g., soccer, football, basketball), the various individuals may utilize whistles or other similar devices. When used by the various individuals presiding over the game, the whistle may indicate change in game phases (e.g., when a play is over) or violation of rules.

Also associated with many sporting events is the use of a timekeeper who is responsible for keeping track of the remaining time for a particular game. The remaining time may be tracked using an official game clock that can be seen by the players and bystanders alike.

In some sports (e.g., football, basketball), the operation of the game clock is associated with the signals via whistles provided by the various individuals presiding over the game. For example, a whistle can be used to indicate when the game clock should be stopped and when the game clock should resume. It may be important that the timekeeper is able to hear the signals coming from the whistle so that accurate timekeeping can be maintained.

Furthermore, it may also be equally important to ensure that the various players are capable of hearing signals via whistles. There may be many obstructions that can prevent one or more players from hearing a whistle from a single referee. For example, the player may be too far from the source or the sound from the fans/crowd may be too loud thereby drowning out the whistle sound. In these cases when one or more players are prevented from hearing the signal, this may delay the overall progression of the game. In some situations where some players have stopped play while others have not, confusion may arise and result in injuries. For example, there may be a situation where a quarterback who has heard the whistle proceeds to end the play due to a signaled in-game violation. But if one or more defensive players fail to hear the same signal, they may continue playing and proceed to tackle the quarterback. Since the quarterback was under the belief that the play had ended, the quarterback may be caught by surprise and may not take the necessary precautions to prevent injury caused by the incoming tackle.

Therefore, there is a need for a system and a method whereby signals provided by, for example, a referee in a sporting event is provided instantaneously to all the players. There is also a need for the system and method to provide the same signal to the timekeeper so accurate timekeeping can be maintained.

### SUMMARY OF THE CLAIMED INVENTION

The present invention relates to a method for notifying a game-based clock and each player associated with the sporting event using one or more digital whistles. The method includes generating a digital signal that is transmitted from the one or more digital whistles. The digital whistles generate the digital signal upon being activated by the owner of the digital whistle (e.g., an individual presiding over the sporting event such as a referee). The digital signal is transmitted to the whistle processor to be processed. The whistle processor identifies the digital signal and generates corresponding instructions that are subsequently transmitted to the game-based clock and each player associated with the sporting event. The transmitted instructions received by the clock and each player are used to inform the clock and each player that a digital whistle has been used.

A system for notifying a game-based clock and each player associated with the sporting event using one or more digital whistles is claimed. The system includes one or more digital whistles and a whistle processor. The whistle processor receives digital signals that are transmitted from one or more digital whistles. The digital whistles generate the digital signal upon being activated by the owner of the digital whistle (e.g., an individual presiding over the sporting event such as a referee). The whistle processor identifies the received digital signal and generates corresponding instructions that are subsequently transmitted to the game-based clock and each player associated with the sporting event. The transmitted instructions received by the clock and each player are used to inform the clock and each player that a digital whistle has been used.

### BRIEF DESCRIPTION OF THE DRAWINGS

FIG. 1 illustrates a system utilizing a digital whistle.

FIG. 2 illustrates a further detailed digital whistle and corresponding detailed player processor.

FIG. 3 illustrates a further detailed whistle processor.

FIG. 4 illustrates a method utilizing a digital whistle.

### DETAILED DESCRIPTION

The systems and methods described herein are directed towards utilizing a wireless activator alongside a whistle. The wireless activator provides a wireless signal to one or more individuals (e.g., players, time keeper) when a referee uses the whistle. In this way, the wireless signal can provide an instantaneous signal received by the one or more individuals to indicate when the play ends and also when the game clock should be stopped. The systems and methods provide a solution that overcomes the potential problem of the signals via the whistles being unheard (i.e., drowned out by the crowd).

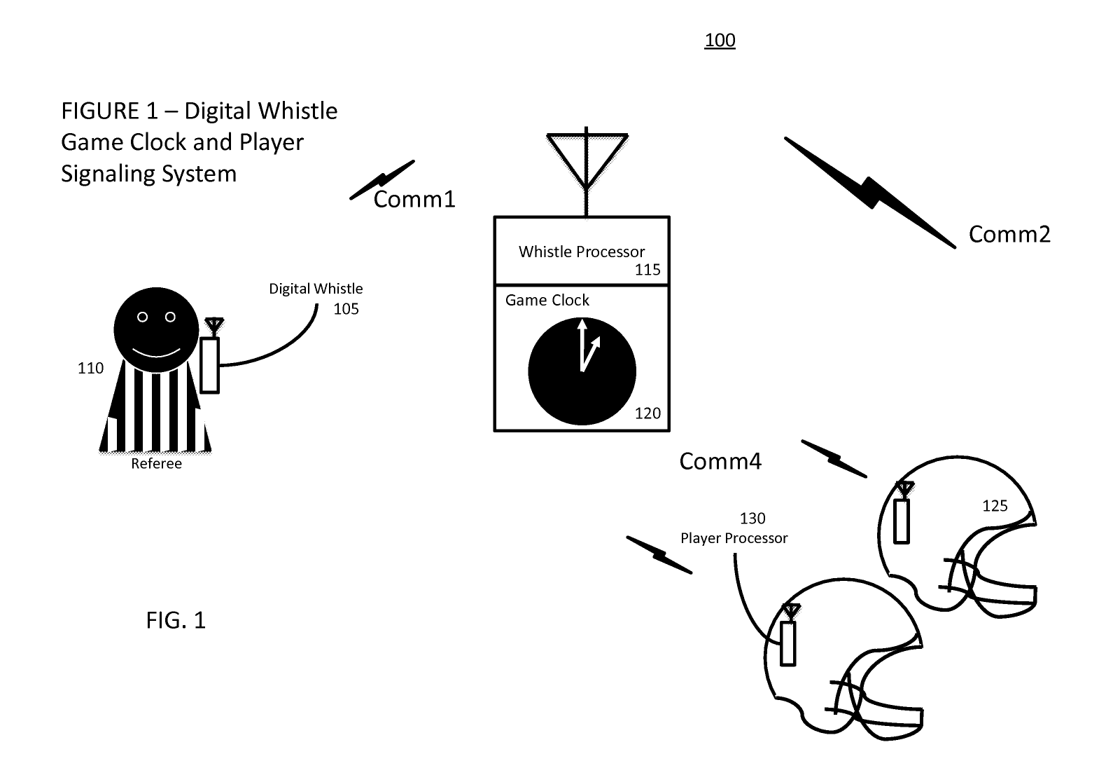

FIG. 1 illustrates a system 100 utilizing a digital whistle 105. A referee 110 may possess and use the digital whistle 105 while presiding over the sporting event. Players 120 may have a player processor 115 situated on their body (e.g., embedded in their helmet, affixed to their uniform) adapted to receive signals from the digital whistle 105. There may also be a whistle processor 125 associated with a game clock 130 to facilitate maintaining accurate time keeping. Further details relating to the various elements of the system 100 are provided below.

As described above, the digital whistle 105 may be used by a referee 110 while the referee 110 is presiding over a particular sporting event. Much like its predecessors, the digital whistle 105 may be used to signal changes in game phases and violations of game rules. The digital whistle 105 may be a whistle that is already in use by a referee 110 presiding over sporting events currently. The digital whistle 105, however, also includes an actuator (not shown) within the digital whistle 105 that activates a wireless transmission upon the digital whistle 105 being blown by the referee 110. The actuator may be any moving or controlling mechanism that upon being triggered, for example, by the breath of the referee, initiates the wireless transmission to all possible recipients. The wireless transmission may be carried out via an antenna associated with the digital whistle 105.

The wireless transmission from the digital whistle 105 may be provided to the whistle processor 115. The whistle processor 115, as indicated above, is associated with the game clock 120. Upon receipt of the wireless transmission, the whistle processor 115 processes the received wireless transmission. The wireless processor 115 will subsequently generate instructions for the corresponding game clock 120 to pause or resume based on its previous state. For example, if the game clock was currently running, a received wireless transmission signal may indicate that the game clock should stop. Furthermore, if the game clock is currently paused, a subsequently received wireless transmission signal may indicate that the game clock should be resumed. The wireless processor 115 may check the current status of the game clock 120 prior to generating instructions for the game clock 120. In some embodiments, the wireless transmission from the digital whistle 105 may be capable of directly providing instructions to the whistle processor 115 whether the game clock should be resumed or stopped.

The whistle processor 115 also processes the received wireless signal from the digital whistle 105 in order to send a signal to each of the players 125 playing in the sporting event. In some embodiments, the whistle processor 115 may include a database of which players the received wireless signal should be provided to (e.g., the current/active players).

The wireless transmission from the whistle processor 115 is received by a player processor 130 associated with each player 125. For example, the player processor 130 may be embedded within a football helmet. In another example, the player processor 130 may be associated with the uniform (e.g., jersey, wristband) of the player 125. In any case, upon receipt of the wireless transmission from the whistle processor 115, the player processor 130 may output an indicator to the player 125 that a digital whistle 105 has been blown. For example, the player processor 130 may produce a tone that the player 125 may more easily hear since the tone would be generated closer to the particular player 125. In other situations, the player processor 130 may also provide vibrations that can be picked by the player 125. In some further situations, the player processor 130 may also provide light-based signals that can be picked up by the player 125 and surrounding players as well.

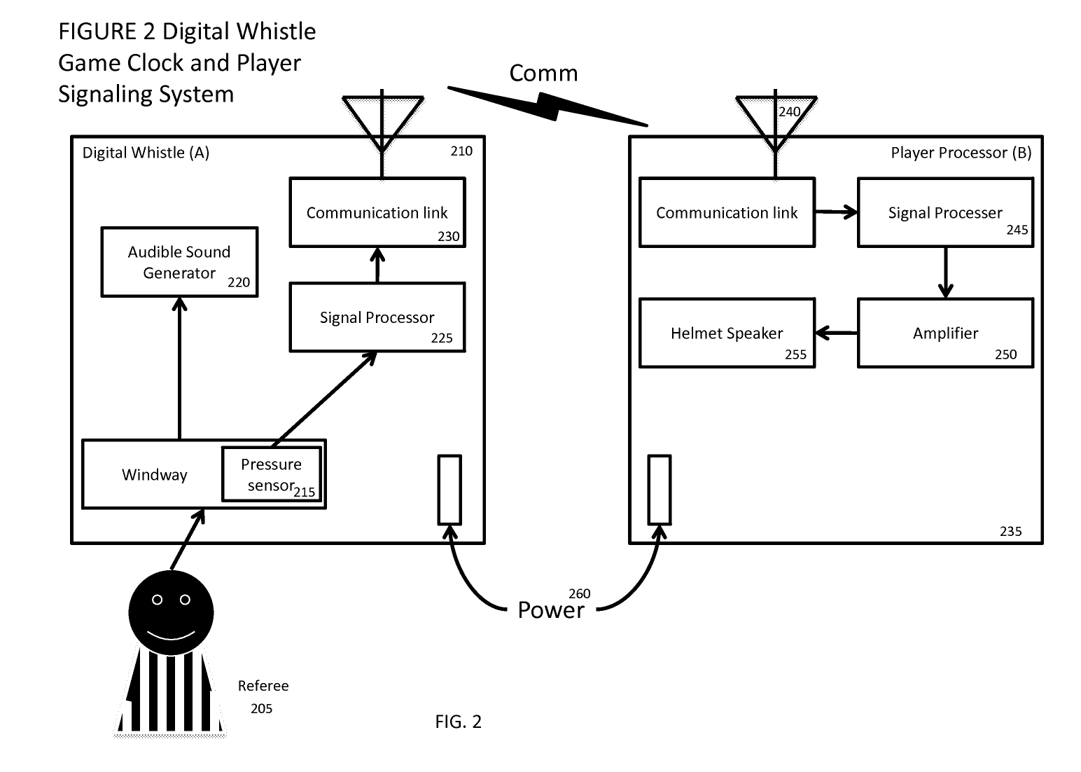

FIG. 2 illustrates a further detailed digital whistle 210 and corresponding detailed player processor 235. The figure illustrates how the signals provided from the referee 205 are processed by the digital whistle 210. The processed signals from the digital whistle 210 are later received by the player processor 235 associated with each player whereby the player processor 235 can be used to inform the player that the digital whistle 210 has been blown.

As illustrated in FIG. 2, the referee 205 may utilize the digital whistle 210 like any other whistle currently used by blowing into the whistle. It should be noted that other ways of utilizing the digital whistle 210 may also be possible (e.g., air pressure, steam).

Upon being blown, the air being emitted from the mouth of the referee 205 transfers into the digital whistle (i.e., windway). From the windway, the digital whistle 210 may produce an auditory tone via an audible sound generator 220 that may be similar to an auditory tone that any normal whistle currently being used may also be capable of producing.

Within the digital whistle 210, an actuator 215 (e.g., pressure sensor) may also be situated. The actuator 215 can be viewed as a switch that controls a wireless transmission from the digital whistle 210. Upon being activated, the actuator 215 may instruct the signal processor 225 to begin processing information regarding the use of the digital whistle 210 by the referee 205. For example, the signal processor 225 may evaluate how long the referee 205 blew into the digital whistle 210. It may be possible that based on the type of information obtained from the use of the digital whistle 210 by the referee 205, different types of information may be obtained and processed by the signal processor 225.

From the signal processor 225, a signal is provided to the communication link 230 of the digital whistle 210. This signal may correspond to the wireless transmission provided to the whistle processor of FIG. 1. In some embodiments, it may be possible that the wireless transmission from the communication link 230 of the digital whistle 210 is provided directly to each of the player processor 235 associated with the players participating in the sporting event.

It may be desired that the digital whistle 210 incorporate some sort of notification for the referee 205 to indicate that the digital whistle 210 received the signal from the referee 205 (e.g., blowing into the whistle). This notification (i.e., local feedback) may be provided via a tone that is generated from the audible sound generator 220 of the digital whistle 210. In some embodiments, the digital whistle 210 may provide other methods of notification (e.g., vibration, lights) that can be used to indicate that the digital whistle 210 had been blown by the referee 205.

The player processor 235, as described above, is used to facilitate notifying each of the players that the digital whistle 210 has been blown. The player processor 235, for example, may be embedded within a helmet (e.g., football helmet) used by the player. In some embodiments, the player processor 235 may be associated with the uniform or attached to the body of the players.

The player processor 235 (which may be the same as or similar to the player processor 130 illustrated in FIG. 1) includes a communication link 240. The communication link 240 facilitates the player processor 235 in receiving inputs from the digital whistle 210. The communication link 240 may also receive inputs from the whistle processor (as illustrated in FIG. 1).

Upon receipt of an input signal from the digital whistle 210 (or whistle processor) at the communication link 240, the input signal is then transmitted to the signal processor 245. The signal processor 245 then processes the input signal, for example, identifying the received input signal and preparing a corresponding output for the player (e.g., sound, light, vibrations).

The output prepared by the signal processor 245 is then provided to an amplifier 250. The amplifier 250 may be used, for example, in situations where the output is an audio-based signal, to amplify the output from the signal processor 245 into a signal that can be heard by the player via speakers 255 associated with the player processor 235. If the player processor 235 is embedded within a player helmet (e.g., football helmet), the amplifier 250 may be required to amplify the signal less since the speakers 255 may be situated in close proximity to the ears of the player. In some embodiments, the amplifier 250 may provide the amplified signal to other output elements (e.g., vibrators, lights) so that the user can be notified (e.g., vibration, flashing lights, colored lights) that the digital whistle 210 has been blown.

Each of the digital whistles 210 and player processors 235 may possess their own power supply 260. The power supply 260 is included as a way for providing power to the digital whistle 210 and player processors 235 for operation. The power supply 260 may be a rechargeable power supply (e.g., battery) that is capable of being re-charged between sporting events.

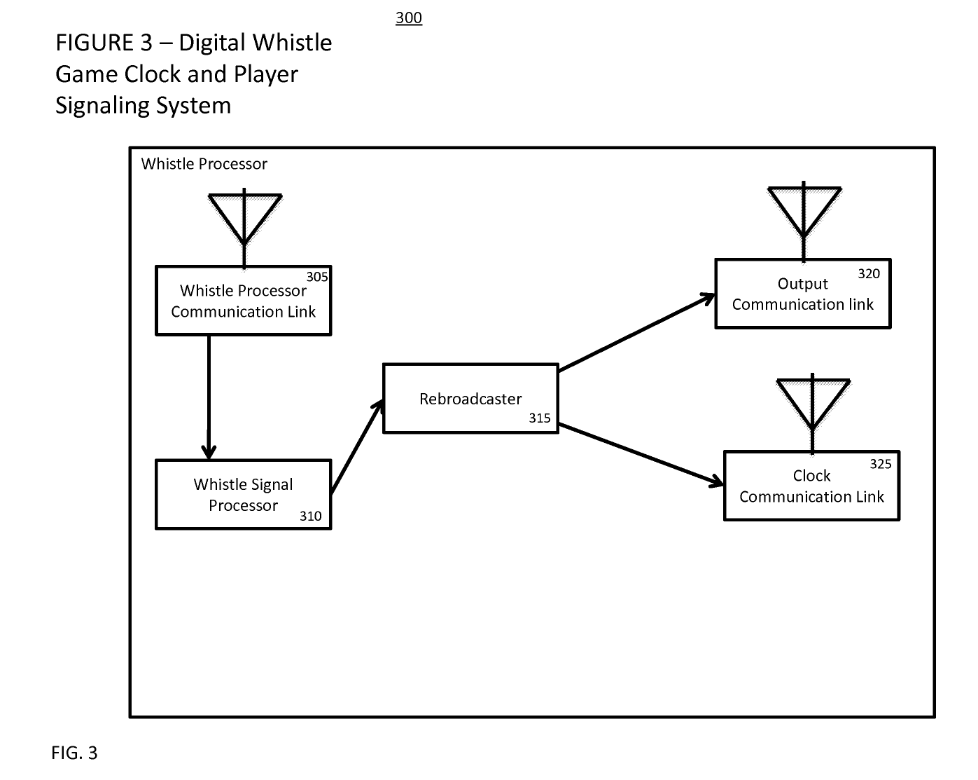

FIG. 3 illustrates a further detailed whistle processor 300. The whistle processor 300 may be similar to the whistle processor 115 illustrated in FIG. 1.

The whistle processor 300 includes a communication link 305. The communication link 305 receives input signals from the digital whistle. The communication link 305 may be turned on or off based on whether the whistle processor 300 is in use. Upon receiving an input signal at the communication link 305 while the whistle processor 300 is turned on, the input signal is provided to the signal processor 310. The input signal can then be processed into an output (e.g., instructions for the clock and/or to each of the players identifying the reason why the whistle is blown). For example, based on the tone and length of the input signal from the digital signal, it may be possible for the whistle processor 300 to identify different situations for why the digital whistle is blown. It may also be possible to identify where the digital signal is being provided from (e.g., which digital whistle) thereby indicating a further layer of reasons why the digital whistle is blown. The whistle processor can utilize these possible variations in the input signal to generate corresponding instructions to match the situation as to why the digital whistle was blown and provide the instructions to the clock and/or the players accordingly.

The output from the signal processor 310 can then be provided to the rebroadcaster 315. The rebroadcaster 315 is used to shape the output from the signal processor 310 so that the output can be provided to the clock and/or players. Instructions to each of the players can be provided to the output communication link 320. Instructions to the clock can be provided to the clock communication link 325. The communication links 320, 325 facilitates providing the output signal to their associated targets (e.g., each of the players, clock).

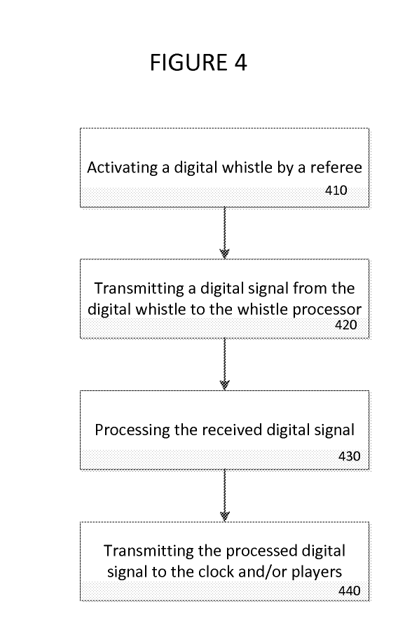

FIG. 4 illustrates a method 400 utilizing a digital whistle. As described above, the method 400 provides a way for a digital signal to be sent from one or more referees presiding over a particular sporting event so that accurate timekeeping (via the clock) and more efficient notification of the status of the game is provided to each of the players within the game.

In step 410, one or more digital whistles are activated. The digital whistles may be used by the individuals (e.g., umpire, referee, officials) presiding over a sporting event. The referees may activate the digital whistles, for example, by blowing into the digital whistle much like existing whistles currently used. The act of blowing into the digital whistle may trigger one or more actuators that initiates a digital signal to be transmitted.

It should be noted that the digital whistle may be activated in other ways other than the act of blowing. For example, the digital whistle may have a corresponding button that the referee may press in order to trigger the actuators for the digital signal. In this way, the referee may be able to transmit a digital signal without actually blowing into the digital whistle. It should be noted that there may be other ways (aside from blowing into the whistle or pressing a button associated with the whistle) that could be used to enable a digital signal to be generated and subsequently transmitted.

In step 420, the one or more digital whistles transmit a corresponding digital signal to the whistle processor. Once the digital signal is provided an input from the referee indicating that the digital signal should be generated for an event (e.g., change in game phase or violation of game rule), the digital whistle can process the received input into the digital signal that will be transmitted. The digital signal is transmitted from the digital whistle to the whistle processor (that may be associated with one or more game clocks used for timekeeping of the sporting event) and/or each player associated with the sporting event.

The type of digital signal provided by the digital whistle may be based on the input provided by the referee. For example, different variations in breath blown into the digital whistle may be detectable. The different variations can be used to indicate different types of signals to be sent. There may be other embodiments where the digital whistle may include a plurality of buttons directed at different signals that can be generated based on the situation detected. For example, one button may be pressed when a violation is detected while a different button may be pressed when a time-out/pause in the game is initiated.

In step 430, the whistle processor processes the received digital signal from the one or more digital whistles. The digital signal received from the one or more digital whistles can signify one or more different reasons. The whistle processor may be capable of discerning the various reasons. For example, there may be a database associated with the whistle processor that the whistle processor can evaluate the received digital signal with. The database may include the various types (e.g., variations) of digital signals that may be transmitted from a digital whistle and received by the whistle processor.

In some situations, an identification of the digital whistle may also impact the situation or reason as to what the digital signal may represent. The digital signal provided from the one or more digital whistles may include identification information directed of providing additional variation as to why a digital signal is sent. The database may include the identification of the various digital whistles stored in the database and the corresponding reasons why a digital signal may have been sent from the particular digital whistle.

In step 440, the whistle processor transmits an output signal to the clock and/or each player. More specifically, once the whistle processor is able to determine why the digital signal is sent from one or more digital whistles, the whistle processor generates instructions that can then be sent to the clock and/or each player playing the sport.

Instructions to the clock may include indicating whether the clock should be stopped or re-started. In some cases, the instructions may be directed at re-adjusting a period of time that is displayed on the clock (e.g., resetting the twenty four shot clock in basketball).

The instructions to each of the players participating in the sporting event (or at least the players currently in the playing area) may be used to notify the receiving player and nearby players that the digital whistle has been blown. For example, if the player processor receives instructions from the whistle processor to end a play, the player processor may utilize its associated resources (e.g., speaker, lights, vibrator) to convey a signal that can be understood by the players to stop play. If colored lights are associated with the player processor, a red light can indicate that play should be stopped. If a speaker is used, a tone or word (e.g., stop) can be outputted so that the various players can hear. If vibrator-type devices are associated with the player processor, the vibrator can generate vibrations that the players can sense that could be used to inform them that play should stop.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claim.

Although the specification and figures may provide various embodiments directed to use of the technology herein within the realm of American football, it should be noted that the technology can be used in a variety of different events and venues including entertainment or cultural events presented at a theater, gymnasium, stadium or other facility involving a group of people. Such events may also include a variety of sporting events such as football (American and global), baseball, basketball, soccer, ice hockey, lacrosse, rugby, cricket, tennis, track and field, golf, cycling, motor sports such as automobile or motorcycle racing, horse racing, Olympic games, and the like; cultural events such as concerts, music festivals, plays, or the opera, and the like; religious events; and more permanent exhibitions such as museums or historic homes.

What is claimed is:

1. A method for notifying a game-based clock and each player associated with the sporting event via one or more digital whistles, the method comprising:
activating one or more digital whistles, wherein the one or more digital whistles are activated by one or more individuals presiding over the sporting event;
transmitting one or more digital signals from the digital whistle to a whistle processor;
processing, by the whistle processor, the one or more digital signals received;
transmitting instructions from the whistle processor to one or more receivers, wherein the transmitted instructions from the whistle processor corresponds with the received digital signals from the digital whistle.

2. The method of claim 1, wherein activation of the one or more digital whistles includes blowing into the digital whistle or pressing a button associated with the digital whistle.

3. The method of claim 1, wherein activation of the one or more digital whistles includes triggering an actuator.

4. The method of claim 1, wherein the one or more digital whistles associated with the one or more individuals presiding over the sporting event each has unique identification information.

5. The method of claim 1, wherein the one or more digital signals transmitted from the digital whistle to the whistle processor includes variations of possible digital signals used to indicate particular reasons why the digital signal is being transmitted from the digital whistle to the whistle processor.

6. The method of claim 1, wherein the processing of the received digital signals includes evaluating the received digital signal against digital signals stored in a database of the whistle processor.

7. The method of claim 6, wherein the database includes information about received digital signals, identification information related to each digital whistle that sends digital signals and corresponding reasons why the digital signal was provided, the reasons corresponding to instructions transmitted to the one or more receivers.

8. The method of claim 1, wherein the one or more receivers includes a clock, the clock being instructed to stop, resume or become set to a particular value based on the received instructions from the whistle processor.

9. The method of claim 1, wherein the one or more receivers includes processors associated with each of the players playing in the sporting event, the processors for triggering one or more indicators used to indicate to the player that the digital whistle has been blown.

10. The method of claim 9, wherein the indicators include lights, vibrators and speakers.

11. A system for notifying a game-based clock and each player associated with the sporting event via one or more digital whistles, the system comprising:
one or more digital whistles; and
a whistle processor comprising a processor and memory that includes instructions to:
receive one or more digital signals transmitted from the digital whistles, wherein the digital whistles have been activated by one or more individuals presiding over the sporting event,
process the one or more digital signals transmitted from the digital whistles, and
transmit instructions to one or more receivers, wherein the transmitted instructions corresponds with the received digital signals from the digital whistle.

12. The system of claim 11, wherein activation of the one or more digital whistles includes blowing into the digital whistle or pressing a button associated with the digital whistle.

13. The system of claim 11, wherein activation of the one or more digital whistles includes triggering an actuator.

14. The system of claim 11, wherein the one or more digital whistles associated with the one or more individuals presiding over the sporting event each has unique identification information.

15. The system of claim 11, wherein the one or more digital signals transmitted from the digital whistle to the whistle processor includes variations of possible digital signals used to indicate particular reasons why the digital signal is being transmitted from the digital whistle to the whistle processor.

16. The system of claim 11, wherein the processing of the received digital signals includes evaluating the received digital signal against digital signals stored in a database of the whistle processor.

17. The system of claim 16, wherein the database includes information about received digital signals, identification information related to each digital whistle that sends digital signals and corresponding reasons why the digital signal was provided, the reasons corresponding to instructions transmitted to the one or more receivers.

18. The system of claim 11, wherein the one or more receivers includes a clock, the clock being instructed to stop, resume or become set to a particular value based on the received instructions from the whistle processor.

19. The system of claim 11, wherein the one or more receivers includes processors associated with each of the players playing in the sporting event, the processors for triggering one or more indicators used to indicate to the player that the digital whistle has been blown.

20. The system of claim 19, wherein the indicators include lights, vibrators and speakers.
